(19) United States
(12) Patent Application Publication
(10) Pub. No.: US 2015/0095540 A1
(43) Pub. Date: Apr. 2, 2015

(54) EXTERNAL DEVICE AND A TRANSMISSION SYSTEM AND THE METHOD OF THE HETEROGENEOUS DEVICE

(71) Applicant: Sunix Co., Ltd., New Taipei City (TW)

(72) Inventors: MING-CHENG LIN, NEW TAIPEI CITY (TW); PEI-FENG HUANG, NEW TAIPEI CITY (TW)

(73) Assignee: SUNIX CO., LTD., New Taipei City (TW)

(21) Appl. No.: 14/042,866

(22) Filed: Oct. 1, 2013

(51) Int. Cl. G06F 13/40

(52) U.S. Cl. CPC G06F 13/4068
USPC 710/301

(57) ABSTRACT

An external device and a transmission system and the method of the heterogeneous device can access the USB3.0 and PCI-E at the same time. The external device includes an USB3.0 socket couples to the host. The USB3.0 socket includes a plurality of first pins and a plurality of second pins. The first control module couples to the second pins. The first control module receives an operation signal via from the host. The micro control unit couples to the first control module via the first pins. The micro control unit receives an identify request via the first pins. The micro control unit generates the operating signal and sends the operating signal to the first control module.

### BACKGROUND OF THE INVENTION

1. Field of the Invention

The instant disclosure relates to an external device, a transmission system and the method of the heterogeneous device; in particular, to an external device, a transmission system and the method of the heterogeneous device connecting the PCI-E interface via the USB 3.0 interface.

2. Description of Related Art

According to the rapid development of integrated circuits, the computer could be small, light and has more computing power. For a small-size computer, the inner space would be limited. Thus, the small-size computer would not provide extension of the interface card. Accordingly, when any one newly added device needs to be added to the small-size computer, the device should be external connected.

Generally, the Universal Serial Bus (USB) is a mature interface for the external device. The advantages of USB are supporting Hot-Plug and Plug-and-Play. Further, the USB 3.0 socket is backward compatible to the conventional USB 2.0 device and the USB 1.1 device.

With the large and fast transmission needs, a new revision of USB standard, so called the USB 3.0, is offered. The capable of transferring data is up to 5 Gbit/s, thus the USB 3.0 provides a faster data transferring speed. Some manufacturers propose to convert other interface to the USB 3.0 interface. Thus, other heterogeneous device could be connected to the computer via the USB 3.0 interface, so as to make a single socket be able to connect with different devices. The other interfaces different from the USB 3.0 interfaces are described as heterogeneous devices in this instant disclosure.

### SUMMARY OF THE INVENTION

The object of the instant disclosure is to offer an external device, a transmission system and a method of the heterogeneous device.

In order to achieve the aforementioned objects, according to an embodiment of the instant disclosure, a heterogeneous transmission system for selecting the corresponding transmission protocol according to the connected device is provided. The heterogeneous transmission system comprises a PCI-E device and a host. The PCI-E device has a first socket, a micro control unit and a first control module. The micro control unit couples to the first control module. The first socket has a plurality of first pins and a plurality of second pins. The host is for connecting to the PCI-E device. The host has a second socket and a second control module. The second socket is set up corresponding to the first socket of the PCI-E device. When the PCI-E device is connected to the host, the second control module is coupled to the micro control unit via the first pin, the second control module is coupled to the first control module via the second pin, the second control module drives the micro control unit via the plurality of first pins, such the micro control unit sends an side band signal to the first control module, the second control module sends an operating signal to the first control module via the second pin.

In order to achieve the aforementioned objects, according to an embodiment of the instant disclosure, an external device for connecting to a PCI-E device via a USB 3.0 socket is provided. The external device comprises a USB 3.0 socket, a first control module and a micro control module. The USB 3.0 socket is connecting to a host. The USB 3.0 socket has a plurality of first pins and a plurality of second pins. The first control module connects to the plurality of second pins of the USB 3.0 socket. The first control module receives an operating signal from the host. The micro control unit couples to the plurality of first pins of the USB 3.0 socket and the first control module, and receives an identify request via the plurality of first pins. The micro control unit generates a side band signal according to the identify request and sends the side band signal to the first control module.

In order to achieve the aforementioned objects, according to an embodiment of the instant disclosure, a transmission method of the heterogeneous device for connecting a PCI-E device via a USB 3.0 socket is provided. The transmission method comprises connecting the PCI-E device to the USB 3.0 socket of a host; a second control module of the host driving a micro control unit of the PCI-E device via a plurality of first pins of the USB 3.0 socket for generating a side band signal; the second control module sending an operating signal to a first control module of the PCI-E device via a plurality of second pins of the USB 3.0 socket; sending the side band signal to the first control module; and the first control module conducting the corresponding operation according to the side band signal and the operating signal.

In summary, the external device, the transmission system and the method of the heterogeneous device provides the correct timing to the operation of the PCI-E device. Thus, the instant disclosure could realize the purpose of hot plugging. The instant disclosure provides that the USB 3.0 socket could not only be connected with a USB 3.0 device but also a PCI-E device. The purpose of saving space could be achieved. The present invention also takes into account the practical purpose.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a schematic diagram of a heterogeneous transmission system according to a first embodiment of the instant disclosure;

FIG. 2 shows a schematic diagram of the pins of a first socket according to an embodiment of the instant disclosure;

FIG. 3 shows a flow chart of a transmission method of the heterogeneous device according to an embodiment of the instant disclosure; and

FIG. 4 shows a flow chart of a transmission method of the heterogeneous device according to another embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

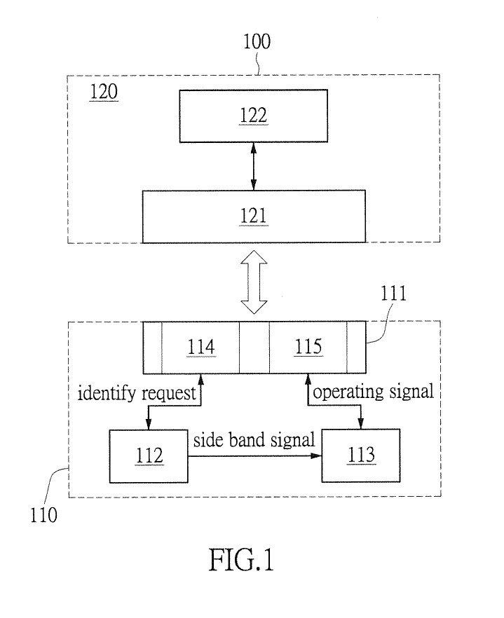

Please refer to FIG. 1 showing a schematic diagram of a heterogeneous transmission system according to a first embodiment of the instant disclosure. The heterogeneous transmission system 100 comprises a PCI-E device 110 and a host 120. The PCI-E device 110 has a first socket 111, a micro control unit (MCU) 112 and a first control module 112 (PCI-E Host). The micro control unit 112 couples to the first socket 111 and the first control module 113. The information and drivers of the PCI-E device 110 could be written into the micro control unit 112. The first socket 111 comprises a plurality of first pins 114 and a plurality of second pins 115. In order to meet the demand of backward compatibility, the USB 3.0 socket comprises the USB 2.0 pins and the USB 3.0 pins. In this embodiment, all of the USB 2.0 pins are defined as the first pins 114, and all of the USB 3.0 pins are defined as the second pins 115. The first pins 114 are coupled to the micro control unit 112 and the host 120. The second pins 115 are coupled to the first control module 113 and the host 120. The first socket 111 utilizes the USB 3.0 transport protocol. The first 111 may be the USB A type or the USB B type.

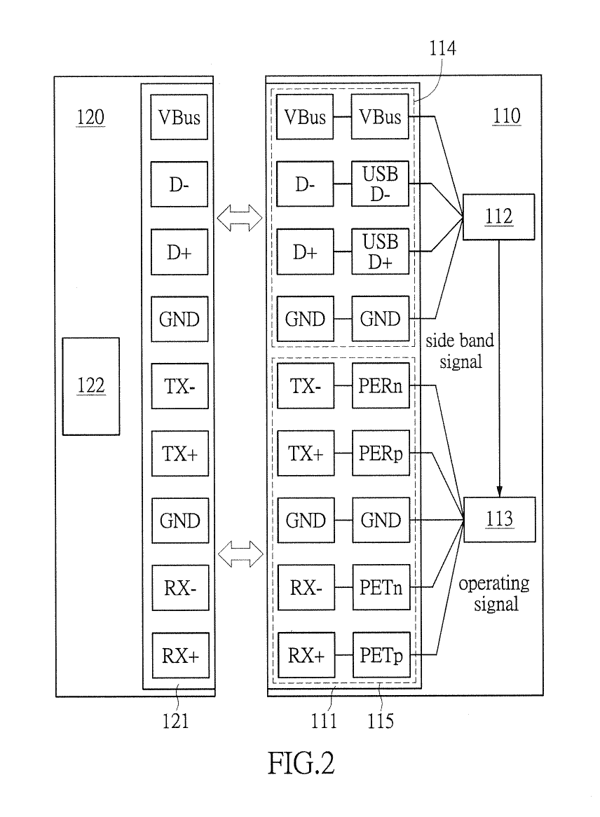

Please refer to FIG. 2 showing a schematic diagram of the pins of a first socket according to an embodiment of the instant disclosure. The pinout of the first socket 111 are described in the following. The pinout of the first socket 111 comprises a pin number one, a pin number two, a pin number three, a pin number fourth, a pin number fifth, a pin number sixth, a pin number seventh, a pin number eighth, and a pin number ninth. The pin number one is the first pin and connects to the power pin (VBus) of USB 2.0 and the power pin (Vcc) of PCI-E. The pin number two is the first pin and connects to the differential voltage pin (D−) of USB 2.0. The pin number three is the first pin and connects to the differential voltage pin (D+) of USB 2.0. The pin number fourth is the first pin and connects to the grounding pin (GND) of USB 2.0 and the grounding pin (GND) of PCI-E.

The pin number fifth is the second pin and connects to the receiving pin (RX−) of USB 3.0 and the PERn pin (PCI Express Receive Negative signal) of PCI-E. The pin number sixth is the second pin and connects to the receiving pin (RX+) of USB 3.0 and the PERp pin (PCI Express Receive Positive signal) of PCI-E. The pin number seventh is the second pin and connects to the grounding pin of USB 3.0 and the grounding pin of PCI-E. The pin number eighth is the second pin and connects to the transmission pin (TX−) and the PETn pin (PCI Express Transmit Negative signal) of PCI-E. The pin number ninth is the second pin and connects to the transmission pin (TX+) and the PETp pin (PCI Express Transmit Positive signal) of PCI-E.

The host 120 may be a personal computer, a notebook or an all in one PC (AIO), but the present invention is not so restricted. The host 120 comprises a second socket 121 and a second control module 122. The kind of the second control module 122 is determined by the operation process of the host 120. When the host 120 is booting, the second control module 122 is the Basic Input/Output System (BIOS), the second control module 122 may drive the platform controller Hub to conduct related processing. When the host 120 is performing the operation system (OS), the second control module 122 is executed by the operation system. The second socket 121 also utilizes the USB 3.0 transport protocol. In general, the type of the first socket 111 is with respect to the type of the second socket 121. A cable of the USB 3.0 may also be utilized to connect the first socket 111 with the second socket 121.

The second control module 122 could be served by different objects according to different operating environment of the host 120. In this embodiment, the operating environment is divided into booting and operation system. When the host 120 is booting, the BIOS represents the second control module 122. After the booting is completed, the host 120 would perform the operation system. In the environment of the operation system, the operation system is responsible for related processing of detecting the plug of the PCI-E device 110.

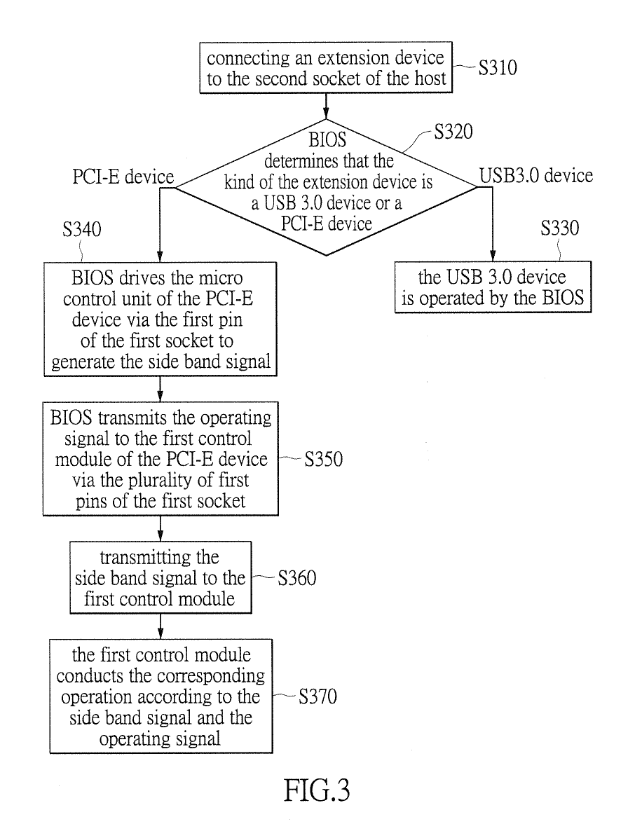

For ease to describe the operating process during booting process of the host 120, please refer to FIG. 3 showing a flow chart of a transmission method of the heterogeneous device according to an embodiment of the instant disclosure. The transmission method of the heterogeneous device comprises following steps:

S310: connecting an extension device to the second socket of the host;

S320: BIOS determines that the kind of the extension device is a USB 3.0 device or a PCI-E device;

S330: the USB 3.0 device is operated by the BIOS;

S340: BIOS drives the micro control unit of the PCI-E device via the first pin of the first socket to generate the side band signal;

S350: BIOS transmits the operating signal to the first control module of the PCI-E device via the plurality of first pins of the first socket:

S360: transmitting the side band signal to the first control module; and

S370: the first control module conducts the corresponding operation according to the side band signal and the operating signal.

In order to distinguish the un-identified device and the identified device, the connected device which is not identified yet is defined as an extension device. The extension device is connected to the host 120 via the cable or connector. Because the host 120 is in the booting status, the BIOS represents the second control module 122.

The BIOS identifies the kind of the extension device by the manner of counting and inquiring the information of the device. After the BIOS sends a identify request, the BIOS waits for the response of the micro control unit 112. Because the micro control unit 112 carries the related information of the PCI-E device 110 or the USB 3.0 device, the micro control unit 112 generates the corresponded responding signal after receiving the identify request. If the BIOS receives the responding signal of the micro control unit 112 during a predetermined time period, the BIOS identifies the PCI-E device. if the BIOS does not receive the responding signal during the predetermined time period, the BIOS deems that the device connecting to the second socket 121 is a USB 3.0 device. If the device connecting to the second socket 121 is a USB 3.0 device, the BIOS interact with the USB 3.0 device by the conventional program.

If the connected extension device is the PCI-E device 110, the BIOS drives the micro control unit 112 of the PCI-E device 10 via the first pins 11 of the first socket 111 to generate the side band signal. The side band signal may comprise the reset signal, the wakeup signal, and the sleep signal. The side band signal generated by the micro control unit 112 meets the control requirement of the PCI-E device 110, thus the PCI-E device 110 may operate with the correct timing. The BIOS sends the operating signal to the first control module 113 via the plurality of the second pins 115 of the first socket 111. The operating signal is the transmit signal (TX) or the receive signal (RX). The executing sequence of the steps S350 and S360 is not so restricted. An artisan of ordinary skill in the art will appreciate how to make the steps S350 and S360 be executed at the same time or change the executing sequence of the steps S350 and S360.

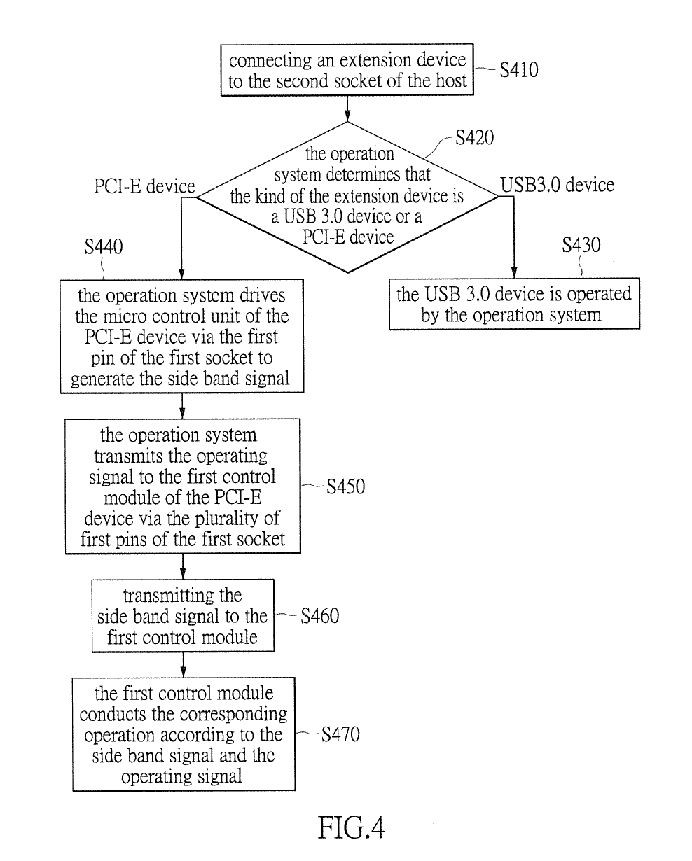

The transmission method of the heterogeneous device could be applied during not only the booting process but also the operation system process. When the operation system is performing, the BIOS would not control the peripheral hardware. Thus the operation system represents the second control module 122 when the operation system is performing. Please refer to FIG. 4 showing a flow chart of a transmission method of the heterogeneous device according to another embodiment of the instant disclosure. This embodiment comprises following steps:

S410: connecting an extension device to the second socket of the host;

S420: the operation system determines that the kind of the extension device is a USB 3.0 device or a PCI-E device;

S430: the USB 3.0 device is operated by the operation system;

S440: the operation system drives the micro control unit of the PCI-E device via the first pin of the first socket to generate the side band signal;

S450: the operation system transmits the operating signal to the first control module of the PCI-E device via the plurality of first pins of the first socket;

S460: transmitting the side band signal to the first control module; and

S470: the first control module conducts the corresponding operation according to the side band signal and the operating signal.

Because the operation system substantive controls the hardware of the host 120, thus the operation system is treated as the second control module 120 after the booting process is completed. When the operation system detects that a device is plugged into the second socket 121, the operation system would call the associated interrupt routine. The interrupt routine may be realized in different manner according to the type of the operation system.

When the extension is connected to the host 120, the operation system sends the identify request to the micro control unit 112 of the PCI-E device 110 via the first pins 114. When the extension device receives the identify request, the micro control unit 112 sends back a responding signal to the host 120. When the operation system receives the responding signal, the operation system identifies the kind of the extension device according to the responding signal, and calls the associated interrupt routine to connect with the device. Taking Windows OS of the Microsoft Corporation as an example, the Windows OS calls the system management interrupt (SMI) or driver to identify or connect with the PCI-E device 110.

Then, the operation system drives the micro control unit 112 of the PCI-E device 110 via the first pins 114 of the first socket 111 to generate the side band signal. The side band signal generated by the micro control unit 112 meets the control requirement of the PCI-E device 110, thus the PCI-E device 110 may operate with the correct timing. The operation system sends the operating signal to the first control module 113 of the PCI-E device 110 via the plurality of the second pins 115 of the first socket 111. An artisan of ordinary skill in the art will appreciate how to make the steps S450 and S460 be executed at the same time or change the executing sequence of the steps S450 and S460.

According to above descriptions, the external device, the transmission system 100 and the method of the heterogeneous device provides the correct timing to the operation of the PCI-E device 110. Thus, the instant disclosure could realize the purpose of hot plugging. The instant disclosure provides that the USB 3.0 socket could not only be connected with a USB 3.0 device but also a PCI-E device 110. The purpose of saving space could be achieved. The present invention also takes into account the practical purpose.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A heterogeneous transmission system, selecting the corresponding transmission protocol according to the connected device, comprising:
a PCI-E device, having a first socket, a micro control unit and a first control module, the micro control unit coupling to the first control module, the first socket having a plurality of first pins and a plurality of second pins; and
a host, for connecting to the PCI-E device, the host having a second socket and a second control module, the second socket being set up corresponding to the first socket of the PCI-E device;
wherein when the PCI-E device is connected to the host, the second control module is coupled to the micro control unit via the first pin, the second control module is coupled to the first control module via the second pin, the second control module drives the micro control unit via the plurality of first pins, such the micro control unit sends a side band signal to the first control module, the second control module sends an operating signal to the first control module via the second pin.

2. The heterogeneous transmission system according to claim 1, wherein the pinout of the first socket comprises:
a pin number one, being the first pin, connecting to the power pin of USB 2.0 and the power pin of PCI-E;
a pin number two, being the first pin, connecting to the differential voltage pin (D−) of USB 2.0;
a pin number three, being the first pin, connecting to the differential voltage pin (D+) of USB 2.0;
a pin number fourth, being the first pin, connecting to the grounding pin of USB 2.0 and the grounding pin of PCI-E;
a pin number fifth, being the second pin, connecting to the receiving pin (RX−) of USB 3.0 and the PERn pin of PCI-E;
a pin number sixth, being the second pin, connecting to the receiving pin (RX+) of USB 3.0 and the PERp pin of PCI-E;
a pin number seventh, being the second pin, connecting to the grounding pin of USB 3.0 and the grounding pin of PCI-E;
a pin number eighth, being the second pin, connecting to the transmission pin (TX−) and the PETn pin of PCI-E; and
a pin number ninth, being the second pin, connecting to the transmission pin (TX+) and the PETp pin of PCI-E.

3. The heterogeneous transmission system according to claim 1, wherein the second control module is a BIOS or an operation system.

4. The heterogeneous transmission system according to claim 3, wherein the BIOS determines the kind of the extension device is a USB 3.0 device or a PCI-E device during the booting process.

5. The heterogeneous transmission system according to claim 3, wherein the operation system determines the kind of the extension device is a USB 3.0 device or a PCI-E device during the booting process.

6. An external device, connecting to a PCI-E device via a USB 3.0 socket, comprising:
the USB 3.0 socket, connecting to a host, having a plurality of first pins and a plurality of second pins;
a first control module, connecting to the plurality of second pins of the USB 3.0 socket, receiving an operating signal from the host; and
a micro control unit, coupling to the plurality of first pins of the USB 3.0 socket and the first control module, receiving an identify request via the plurality of first pins, generating a side band signal according to the identify request, sending the side band signal to the first control module.

7. A transmission method of the heterogeneous device, for connecting a PCI-E device via a USB 3.0 socket, comprising:
connecting the PCI-E device to the USB 3.0 socket of a host;
a second control module of the host driving a micro control unit of the PCI-E device via a plurality of first pins of the USB 3.0 socket for generating an side band signal;
the second control module sending an operating signal to a first control module of the PCI-E device via the plurality of second pins of the USB 3.0 socket;
sending the side band signal to the first control module; and
the first control module conducting the corresponding operation according to the side band signal and the operating signal.

8. The transmission method according to claim 7, wherein the second control module is a BIOS or an operation system.

9. The transmission method according to claim 8, wherein connecting the PCI-E device to the USB 3.0 socket comprising:
determining the host is booting or performing the operation system;
the BIOS determining the kind of the device connecting to the USB 3.0 socket is a USB 3.0 device or the PCI-E device when the host is booting; and
the operation system determining the kind of the device connecting to the USB 3.0 socket is the USB 3.0 device or the PCI-E device when the host is performing the operation system.

10. The transmission method according to claim 9, wherein determining the kind of the device connecting the USB 3.0 socket further comprising:
the second control module sending an identify request to the device connecting to the USB 3.0 socket;
the PCI-E device generating a responding signal according to the identify request and sending the responding signal to the second control module when the device connecting to the USB 3.0 socket is the PCI-E device;
the USB 3.0 device generating another responding signal according to the identify request and sending the responding signal to the second control module when the device connecting to the USB 3.0 socket is the USB 3.0 device.
